(19) United States
(12) Patent Application Publication
(10) Pub. No.: US 2003/0062851 A1
(43) Pub. Date: Apr. 3, 2003

(54) Method and paste for joiningcut surfaces of ferrite cores for fluorescent lamps

(75) Inventor: John W. Shaffer, Danvers, MA (US)

Correspondence Address: Carlo S. Bessone, OSRAM SYLVANIA INC., 100 Endicott Street, Danvers, MA, 01923, US

(73) Assignee: OSRAM SYLVANIA INC.

(21) Appl. No.: 09/935,112

(22) Filed: Aug. 22, 2001

(51) Int. Cl. H05B 41/16

(52) U.S. Cl. 315/248; 315/246

(57) ABSTRACT

A method for joining cut surfaces of different portions of a ferrite core for a fluorescent lamp includes the steps of providing a high magnetic permeability paste, applying the paste to the cut surface of at least one of the core portions, abutting the cut surfaces and squeezing out and removing excess paste. The paste is an admixture of ferromagnetic material and a suitable carrier material.

### BACKGROUND OF THE INVENTION

1. Field of the Invention

The invention relates to electrodeless fluorescent lamps and is directed more particularly to a method for joining cut surfaces of different portions of a ferrite core for a fluorescent lamp, and is further directed to a paste for disposition between the cut surfaces of the core portions.

2. Description of the Prior Art

Electrodeless fluorescent lamps are disclosed in U.S. Pat. No. 3,500,118 issued Mar. 10, 1970 to Anderson; U.S. Pat. No. 3,987,334 issued Oct. 19, 1976 to Anderson; Anderson, Illuminating Engineering, April 1969, pages 236-244, and in U.S. Pat. No. 6,175,197, issued Jan. 16, 2001 to Kling. An electrodeless, inductively-coupled lamp, as disclosed in these references, includes a low pressure mercury/buffer gas discharge in a discharge tube which forms a continuous, closed electrical path. The path of the discharge tube goes through the center of one or more toroidal ferrite cores such that the discharge tube becomes the secondary of a transformer. Power is coupled to the discharge by applying sinusoidal voltage to a few turns of wire wound around the toroidal core that encircles the discharge tube. A current through the primary winding creates a time-varying magnetic flux which induces along the discharge tube a voltage that maintains the discharge. The inner surface of the discharge tube is coated with a phosphor which emits visible light when irradiated by photons emitted by the excited mercury atoms. The lamp parameters described by Anderson produce a lamp which has a high core loss and is therefor extremely inefficient. In addition, the Anderson lamp is impractically heavy because of the mass of ferrite material needed in the transformer core.

An electrodeless lamp assembly having high efficiency is disclosed in U.S. Pat. No. 5,834,905 issued Nov. 10, 1998 to Godyak. The disclosed lamp assembly comprises an electrodeless lamp including a closed-loop, tubular lamp envelope enclosing mercury vapor and a buffer gas at a pressure less than about 0.5 torr, a transformer core disposed around the lamp envelope, an input winding disposed on the transformer core and a radio frequency power source coupled to input winding. The radio frequency power source typically has a frequency in a range of about 100 kHz to about 400 kHz. The radio frequency source supplies sufficient radio frequency energy to the mercury vapor and the buffer gas to produce in the lamp envelope a discharge having a discharge current equal to or greater than about 2 amperes. The disclosed lamp assembly achieves relatively high lumen output, high efficacy and high axial lumen density simultaneously, thus making it an attractive alternative to conventional VHO fluorescent lamps and high intensity, high pressure discharge lamps.

Another type of electrodeless lamp is disclosed in U.S. Pat. No. 4,298,828 issued Nov. 3, 1981 to Justice et al. A globe-shaped lamp, wherein the discharge path is irregular in shape and is confined to an approximately spherical lamp envelope, is disclosed. A transformer core is located within the lamp envelope.

Yet another type of electrodeless lamp is disclosed in U.S. Pat. No. 5,239,238 issued Aug. 24, 1993 to Bergervoet et al. A transformer core is positioned in a reentrant cavity of a generally globe-shaped electrodeless lamp envelope.

Referring to FIGS. 1-3 herewith, it will be seen that a known lamp 10 includes a lamp envelope 12 which has a tubular, closed-loop configuration and is electrodeless. The lamp envelope 12 encloses a discharge region 14 containing a buffer gas and mercury vapor. A phosphor coating may be formed on the inside surface of lamp envelope 12. Radio frequency (RF) energy from an RF source 20 (FIG. 3) is inductively coupled to the electrodeless lamp 10 by a first transformer core 22 and a second transformer core 24. Each of the transformer cores 22 and 24 preferably has a toroidal configuration that surrounds lamp envelope 12. The RF source 20 is connected to a winding 30 on first transformer core 22 and a winding 32 on second transformer core 24, by leads 27 and 29.

In operation, RF energy is inductively coupled to a low pressure discharge within lamp envelope 12 by transformer cores 22 and 24. The electrodeless lamp 10 acts as a secondary circuit for each transformer. The windings 30 and 32 are preferably driven in phase and may be connected in parallel, as shown in FIG. 3. The transformer cores 22 and 24 are positioned on lamp envelope 12 such that the voltages induced in the discharge by the transformer cores 22 and 24 add. The RF current through the windings 30 and 32 creates a time-varying magnetic flux which induces along the lamp envelope a voltage that maintains a discharge. The discharge within lamp envelope 12 emits ultraviolet radiation which stimulates emission of visible light by the phosphor coating. In this configuration, the lamp envelope 12 is fabricated of a material, such as glass, that transmits visible light.

The lamp envelope preferably has a cross-sectional diameter in a range of about 1 inch to about 4 inches for high lumen output. The fill material comprises a buffer gas and a small amount of mercury which produces mercury vapor. The buffer gas is preferably a noble gas and is most preferably krypton. It has been found that krypton provides higher lumens per watt in the operation of the lamp at moderate power loading. At higher power loading, use of argon may be preferable. The lamp envelope 12 can have any shape which forms a closed loop, including an oval shape, a circular shape, an elliptical shape or a series of straight tubes joined to form a closed loop. In the example of FIGS. 1-3, lamp envelope 12 includes two straight tubes 54 and 56 in a parallel configuration. The tubes 54 and 56 are interconnected at or near one end by a lateral tube 58 and are interconnected at or near the other end by a lateral tube 60. Each of the lateral tubes, or bridges, 58 and 60 provides gas communication between straight tubes 54 and 56, thereby forming a closed-loop configuration. The transformer core 22 is mounted around bridge 58, and transformer core 24 is mounted around bridge 60. Straight tube 54 includes an exhaust tabulation 70, and straight tube 56 includes an exhaust tubulation 72.

The transformer cores 22 and 24 are preferably fabricated of a high permeability, low-loss ferrite material, such as manganese zinc ferrite. The transformer cores 22 and 24 form a closed loop around lamp envelope 12 and typically have a toroidal configuration, with an inside diameter that is slightly larger than the outside diameter of lamp envelope 12. The windings 30 and 32 may each comprise a few turns of wire of sufficient size to carry the primary current. Each transformer is configured to step down the primary voltage and to step up the primary current, typically by a factor of about 5 to 25. The RF source 20 is preferably in a range of about 50 kHz to about 3 MHz and is preferably in a range of about 100 kHz to about 400 kHz.

The discharge lamp may further include a core retainer 80 around transformer core 22 and a core retainer 82 around transformer core 24. Each core retainer 80, 82 may be in the form of a generally U-shaped metal band having mounting holes 84 (FIG. 1) for securing the respective transformer cores in fixed positions, for example, in a lamp fixture. The core retainers 80 and 82 may be secured on transformer cores 22 and 24 by springs 86 and 88, respectively, The core retainers 80 and 82 and the springs 86 and 88 hold the split transformer cores together around the lamp envelope.

In an example of an electrodeless discharge lamp, the lamp envelope is made of 500 millimeter outside diameter Pyrex glass having a composition of 81% SiO₂, 13% B₂O₃, 4% Na₂O and 2% Al₂O₃ enclosing a discharge volume in the form of an elongated toroid. The gas fill includes 0.3 torr krypton and 10 milligrams (mg) of mercury which is amalgamated with 300 mg of an alloy of bismuth:tin:lead in a ratio of 46:34:20 by weight.

The transformer cores 22 and 24 are VOGT Fi325 material of size R61, which have been cut in half. Each core has a primary winding of eleven turns. The primary windings are connected in parallel to RF source 20 and may be 24 gauge teflon insulated copper wire.

The core retainers 80 and 82 and leaf springs 86 and 88 hold the respective cores together. The core retainers 80 and 82, which typically are aluminum, also conduct heat from the core to the lamp fixture. A tab 90 functions as a thermal bridge between an amalgam in the exhaust tubulation 72 and the transformer core 22.

The RF source 20 has an output frequency in a range of 200 kHz to 300 kHz and operates the lamp at about 140 watts when the lamp is equilibrated. The RF source 20 provides a high initial voltage to ensure fast starting.

The above-described electrodeless lamp, illustrated in FIGS. 1-3, is shown and fully described in the aforementioned U.S. Pat. No. 6,175,197, incorporated herein by reference.

In order for the ferrite cores of such lamps to be assembled about the lamp, it is necessary that the torodial cores be cut into two or more sections. During lamp assembly, the sections are again brought together to complete their magnetic circuit and are held in contact with one another by leaf springs 86, 88.

The required cutting of the cores always introduces some degree of roughness to the cut surfaces. Re-joining the cut sections then results in their contacting only at ‘high spots’ leaving an associated air gap between much of the surface area between the core sections. Such an air gap significantly decreases the effective permeability of the ferrite core as compared to an uncut core, and decreases the electrical inductance of any windings thereon. This reduced and highly variable inductance, in turn, affects lamp starting and electrical behavior, particularly when lamps are driven from mass-produced ballasts that are not individually matched electrically to their associated lamp.

It is routine practice in the ferrite industry to enhance the effective permeability of cut cores and reduce their magnetic variability by mechanically grinding or lapping the cut surfaces so as to achieve highly polished mating surfaces. Such secondary operations significantly increase the cost of the ferrite cores and of the final ferrite-containing product to the consumer.

### SUMMARY OF THE INVENTION

Accordingly, an object of the invention is to provide a method for joining cut surfaces of different portions of a ferrite core for use in an electrodeless fluorescent lamp.

A further object is to provide a paste which may be disposed between the ferrite core cut surfaces when the surfaces are joined.

With the above and other objects in view, a feature of the invention is the provision of a method for joining cut surfaces of different portions of a ferrite core for a fluorescent lamp. The method comprises the steps of providing a high magnetic permeability paste comprising an admixture of a ferromagnetic material and a carrier therefor, applying the paste to the cut surface of at least one of the core portions, and abutting the cut surfaces and squeezing out and removing excess paste.

In accordance with a further feature of the invention, there is provided a high magnetic permeability paste for disposition between cut surfaces of different portions of a ferrite core for a fluorescent lamp. The paste comprises an admixture of ferromagnetic material, and a carrier material therefor.

In accordance with a still further feature of the invention, there is provided an electrodeless fluorescent lamp assembly comprising a closed loop tubular lamp envelope enclosing a fill material for supporting a low pressure discharge, a transformer core disposed in proximity to the lamp envelope, the transformer core comprising a plurality of core sections, an input winding disposed on the transformer core for receiving radio frequency energy from a radio frequency source, the radio frequency energy producing the low pressure discharge in the lamp envelope, and a high magnetic permeability paste disposed between surfaces of the core sections, the paste comprising an admixture of ferromagnetic material and a carrier therefor.

The above and other features of the invention, including various novel details of construction and combinations of components and method steps, will now be more particularly described with reference to the accompanying drawings and pointed out in the claims. It will be understood that the particular methods and materials embodying the invention are described by way of illustration only and not as limitations of the invention. The principles and features of this invention may be employed in various and numerous embodiments without departing from the scope of the invention.

### BRIEF DESCRIPTION OF THE DRAWINGS

Reference is made to the accompanying drawings in which is shown an illustrative embodiment of the invention, from which its novel features and advantages will be apparent.

In the drawings:

FIG. 1 is a plan view of a known electrodeless lamp assembly;

FIG. 2 is a side elevational view of the lamp assembly of FIG. 1;

FIG. 3 is a diagrammatic illustration of a core subassembly used in the lamp of FIGS. 1 and 2; and

FIG. 4 is similar to FIG. 3, but showing one form of core subassembly illustrative of embodiments of the invention.

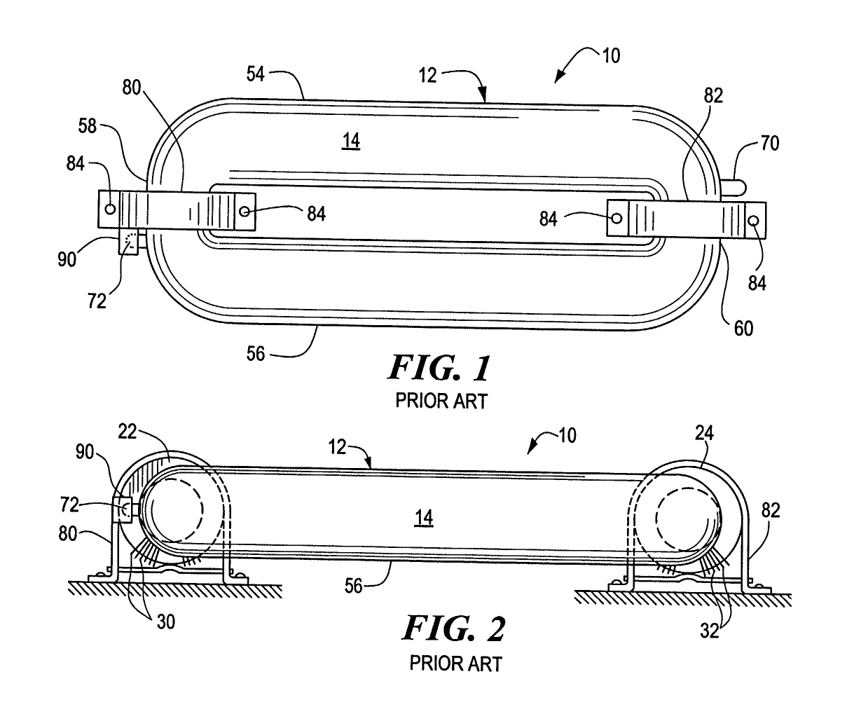

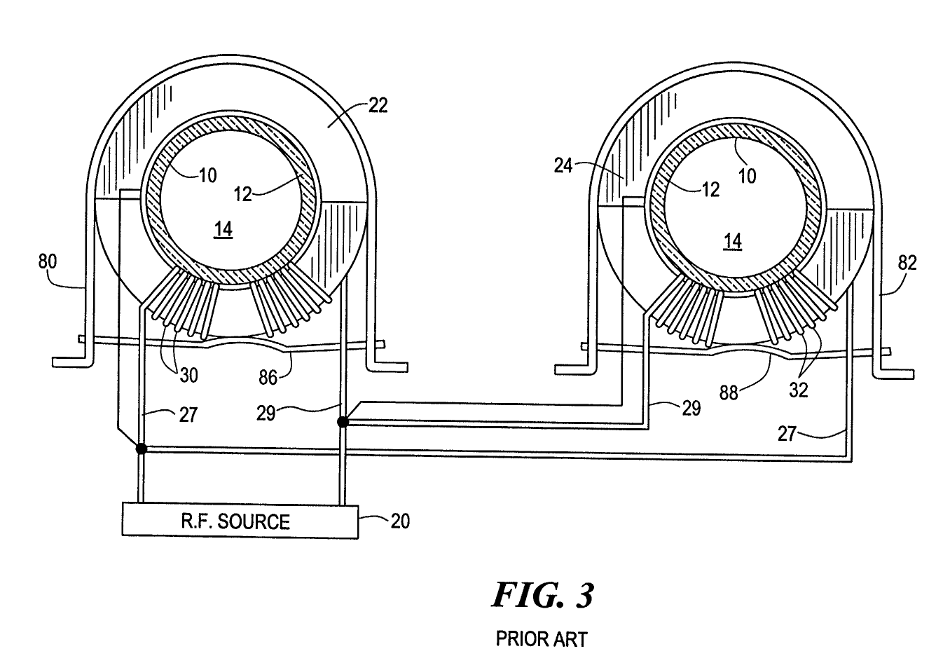

### DESCRIPTION OF THE PREFERRED EMBODIMENTS

It has been found that the use of a high magnetic permeability paste between the mating faces of cut cores substantially increases the effective permeability and inductance of the rejoined core and improves the magnetic uniformity from core to core. Such use of magnetic paste eliminates the need for lapping or other costly secondary core finishing operations. The paste comprises an admixture of ferromagnetic material and a suitable carrier.

The admixture includes about 70 to 95%, by weight, of the ferromagnetic material, depending upon the particle shape and size distribution of the ferromagnetic particles in the material, and the resulting Theological properties that are desired for core assembly. Spherical particles are preferred and the admixture preferably includes between 75 and 87%, by weight, of ferromagnetic material. The balance of the paste comprises a suitable carrier material, preferably a silicone, or a high-temperature epoxy resin, or a high temperature organic resin. By “high temperature” it is meant that continued use at about 160° C. does not break down the paste.

Inasmuch as the ultimate effective magnetic permeability of the reassembled core is highly dependent upon the degree of separation between the core sections, and the minimum separation is limited by the largest particles present in the ferromagnetic material, the ferromagnetic particles should be as small as technically and economically practical. It is preferred that particles be used which have been size classified, with a maximum particle size of less than 30 microns, and preferably less than 10 microns.

It has further been found that the use of round or essentially spherical ferromagnetic particles facilitates “squeeze out” of any excess paste from between the mating faces of the ferrite, and contributes substantially to the minimization of the thickness of the paste-filled gap, and maximizes effective assembly core permeability.

The high magnetic permeability paste thus comprises an admixture of (1) ferromagnetic material, and (2) a suitable carrier material.

The ferromagnetic material may be a selected one of iron powder, Fe3Si (3% silicon), FeSiAl (9% silicon, 6% aluminum), or other iron-containing material or alloys. The ferromagnetic material comprises, by weight, about 70%-95% of the admixture, and preferably about 75%-87% of the admixture. The ferromagnetic particles are less than 30 microns in their longest dimension, and preferably less than 10 microns. The particles preferably, but not necessarily, are spherical with a diameter of less than 30 microns, and preferably less than 10 microns. When iron powder is used, a mesh size of about 325 is preferred.

As noted above, the carrier material may be a selected one of (1) a silicone, (2) a high temperature epoxy resin, and (3) a high temperature organic resin. The silicone may comprise a silicone resin, or high vacuum silicone grease, or silicone vacuum thread lubricant, and the like. The paste, when of an epoxy resin, or other thermo-set resin, may cure either initially or in the course of use. However, non-curing silicone carriers and organic carriers remain “paste-like” indefinitely and do not “cure” or harden. Thus, usually the core sections are not held together, or cemented together by the paste, but rather are held together by the leaf springs 86, 88 with the paste filling any gap 110 between the cut surfaces.

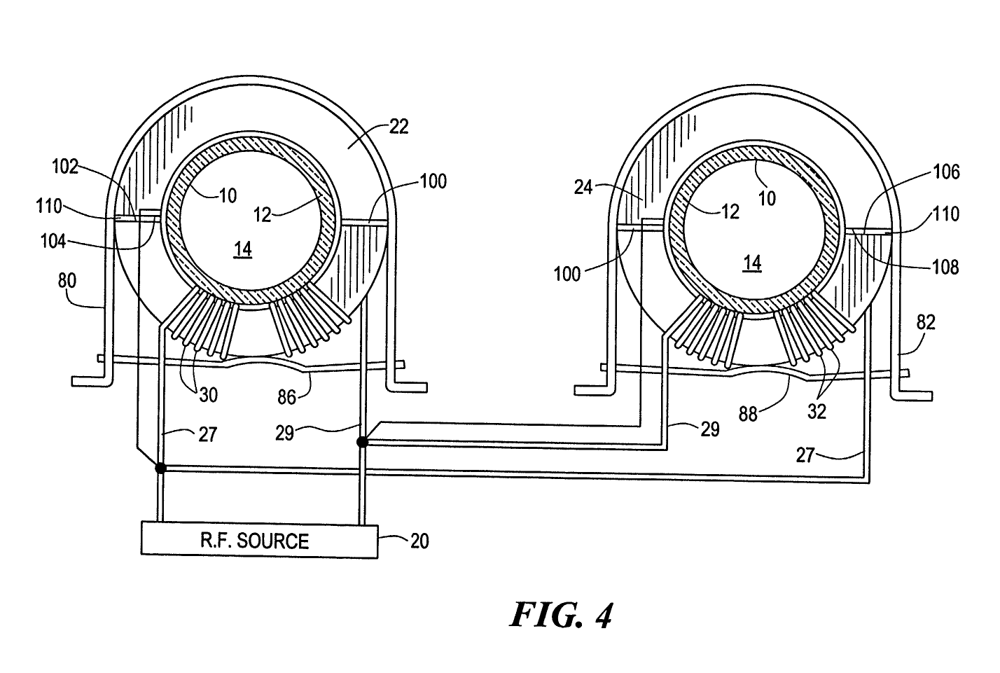

The inventive method includes providing the paste 100, which consists of the admixture described above, applying the paste 100 to at least one of cut surfaces 102, 104 and to at least one of cut surfaces 106, 108 (FIG. 4) of the cores 22,24, adjoining the cut surfaces 102 and 104 with each other with the paste 100 therebetween, and similarly adjoining the cut surfaces 106 and 108 with each other with the paste therebetween, and removing the excess paste 100 which is squeezed out of the area between the mating surfaces in the course of moving the surfaces into substantial adjoinment. The paste is applied in sufficient quantities to fill all voids between the adjoining surfaces and eliminate all air gaps.

The use of the above-described paste and method to join sections of cut ferrite cores increases the effective permeability of the cores 22, 24, increases the inductance of the wire wound cores, and reduces costs by eliminating the need for post-cutting core processing operations, such as lapping and/or grinding.

While the use of rounded or spherical ferromagnetic particles is not necessary, it is preferred inasmuch as rounded particles readily squeeze out from between the cut ferrite surfaces 102 and 104, 106 and 108, to minimize the size of the paste-filled gap 110 which, in turn, maximizes the effective magnetic permeability of the core.

### EXAMPLE 1

A magnetic paste was prepared comprising 75% by weight −325 mesh iron powder, and 25% by weight silicone vacuum thread lubricant. This was a stiff paste with maximized iron powder content.

An as-cut, non-lapped toroidal manganese-zinc ferrite core of 64 mm outside diameter, 41 mm inside diameter, and 18 mm height was clamped together and its 18-turn inductance was measured at room temperature. A small quantity of the above paste, sufficient to fully cover the cut surface, was then applied to each interface of the core and it was re-clamped, as shown in FIG. 4, and excess paste squeezed out and removed. The inductance was then again measured.

| Results: | Initial inductance (uH) | Inductance with Paste (uH) |
|---|---|---|
| | 669 | 725 |

| | |
|---|---|
| Percent inductance increase with paste: | 8.4 |

### EXAMPLE 2

A magnetic paste was prepared comprising 85% by weight Fe3Si (iron, 3% silicon), spherical powder of particle size less than 20 microns, and 15% by weight high vacuum silicone grease.

Eight as-cut, non-lapped toroidal manganese-zinc ferrite core halves of 64 mm outside diameter, 41 mm inside diameter, and 18 mm height were clamped together and their 18-turn inductance was measured at room temperature. A small quantity of the above paste, sufficient to fully cover the cut surface, was then applied to each interface and the cores were re-clamped and excess paste squeezed out and removed. The inductance was then again measured.

| Results: | Initial inductance (uH) | Inductance with Paste (uH) |
|---|---|---|
| Average | 699 | 835 |
| Std. Deviation | 78.0 | 31.1 |
| Range | 561-789 | 775-873 |

| | |
|---|---|
| Percent inductance increase with paste: | 19.5 |

### EXAMPLE 3

A magnetic paste was prepared comprising 75% by weight FeSiAl (iron, 9% silicon, 6% aluminum), spherical powder of particle size less than 10 microns, and 25% by weight silicone vacuum thread lubricant.

Fourteen as-cut, non-lapped toroidal manganese-zinc ferrite core halves of 64 mm outside diameter, 41 mm inside diameter, and 18 mm height were clamped together and their 18-turn inductance was measured at room temperature. A small quantity of the above paste, sufficient to fully cover the cut surface, was then applied to each interface and the cores were re-clamped and excess paste squeezed out and removed. The inductance was then again measured.

| Results: | Initial inductance (uH) | Inductance with Paste (uH) |
|---|---|---|
| Average | 728 | 857 |
| Std. Deviation | 57.2 | 26.3 |
| Range | 644-813 | 811-911 |

| | |
|---|---|
| Percent inductance increase with paste: | 17.7 |

### EXAMPLE 4

A magnetic paste was prepared comprising 80% by weight FeSiAl (iron, 9% silicon, 6% aluminum), spherical powder of particle size less than 10 microns, and 20% by weight silicone vacuum thread lubricant.

Eleven as-cut, non-lapped toroidal manganese-zinc ferrite core halves of 64 mm outside diameter, 41 mm inside diameter, and 18 mm height were clamped together and their 18-turn inductance was measured at room temperature. A small quantity of the above paste, sufficient to fully cover the cut surface, was then applied to each interface and the cores were re-clamped and excess paste squeezed out and removed. The inductance was then again measured.

| Results: | Initial inductance (uH) | Inductance with Paste Cull) |
|---|---|---|
| Average | 719 | 866 |
| Std. Deviation | 63.6 | 23.9 |
| Range | 647-829 | 824-898 |

| | |
|---|---|
| Percent inductance increase with paste: | 20.4 |

### EXAMPLE 5

A magnetic paste was prepared comprising 85% by weight FeSiAl (iron, 9% silicon, 6% aluminum), spherical powder of particle size less than 10 microns, and 15% by weight silicone vacuum thread lubricant.

Fourteen as-cut, non-lapped toroidal manganese-zinc ferrite core halves of 64 mm outside diameter, 41 mm inside diameter, and 18 mm height were clamped together and their 18-turn inductance was measured at room temperature. A small quantity of the above paste, sufficient to fully cover the cut surface, was then applied to each interface and the cores were re-clamped and excess paste squeezed out and removed. The inductance was then again measured.

| Results: | Initial inductance (uH) | Inductance with Paste (uH) |
|---|---|---|
| Average | 727 | 886 |
| Std. Deviation | 64.4 | 17.9 |
| Range | 648-825 | 871-921 |

| | |
|---|---|
| Percent inductance increase with paste: | 21.9 |

### EXAMPLE 6

A magnetic paste was prepared comprising 87% by weight FeSiAl (iron, 9% silicon, 6% aluminum), spherical powder of particle size less than 10 microns, and 13% by weight high temperature epoxy resin.

Thirteen as-cut, non-lapped toroidal manganese-zinc ferrite core halves of 64 mm outside diameter, 41 mm inside diameter, and 18 mm height were clamped together and their 18-turn inductance was measured at room temperature. A small quantity of the above paste, sufficient to fully cover the cut surface, was then applied to each interface and the cores were re-clamped and excess paste squeezed out and removed. The inductance was then again measured.

| Results: | Initial inductance (uH) | Inductance with Paste (uH) |
|---|---|---|
| Average | 717 | 894 |
| Std. Deviation | 50.1 | 19.5 |
| Range | 663-804 | 859-915 |

| | |
|---|---|
| Percent inductance increase with paste: | 21.9 |

It will be understood that many additional changes in the details, materials, steps and arrangement of parts, which have been herein described and illustrated in order to explain the nature of the invention, may be made by those skilled in the art within the principles and scope of the invention as expressed in the appended claims. For example, while iron has been discussed above as a preferred ferromagnetic particle, the particles may alternatively comprise nickel or cobalt, or alloys thereof with alloying components, such as silicon, chromium, and the like.

What is claimed is:

1. A method for joining cut surfaces of different portions of a ferrite core said method comprising the steps of:
providing a high magnetic permeability paste comprising an admixture of a ferromagnetic material and a carrier therefor;
apply the paste to the cut surface of at least one of the core portions; and
abutting the cut surfaces and squeezing out and removing excess paste.

2. The method in accordance with claim 1 wherein the carrier comprises a selected one of a group consisting of (i) silicone, (ii) high temperature epoxy resin, and (iii) a high temperature organic material.

3. The method in accordance with claim 1 wherein the ferromagnetic material comprises ferromagnetic particles.

4. The method in accordance with claim 1 wherein the ferromagnetic material comprises by weight about 70%-95% of the admixture.

5. The method in accordance with claim 1 wherein the ferromagnetic material comprises by weight about 75%-87% of the admixture.

6. The method in accordance with claim 3 wherein the ferromagnetic particles comprise a selected one of a group consisting of iron, nickel, cobalt, and alloys thereof.

7. The method in accordance with claim 3 wherein the ferromagnetic particles comprise iron powder.

8. The method in accordance with claim 7 wherein the iron powder is no greater than about −325 mesh.

9. The method in accordance with claim 3 wherein the particles are less than 30 microns in a longest dimension.

10. The method in accordance with claim 3 wherein the particles are less than 10 microns in a longest dimension.

11. The method in accordance with claim 3 wherein the particles are spherical and less than 30 microns in diameter.

12. The method in accordance with claim 2 wherein the silicone carrier is a selected one of (i) a silicone resin, (ii) high vacuum silicone grease, and (iii) silicone vacuum thread lubricant.

13. A high magnetic permeability paste for joining cut surfaces of different portions of a ferrite core for a fluorescent lamp, said paste comprising an admixture of:
ferromagnetic material, and
a carrier material therefor.

14. The paste in accordance with claim 13 wherein said carrier material comprises a selected one of a group consisting of (i) silicone, (ii) high temperature epoxy resin, and (iii) a high temperature orgainic material.

15. The paste in accordance with claim 13 wherein said ferromagnetic material comprises ferromagnetic particles.

16. The paste in accordance with claim 13 wherein said ferromagnetic material comprises by weight about 70%-95% of the admixture.

17. The paste in accordance with claim 13 wherein said ferromagnetic material comprises by weight about 75%-87% of the admixture.

18. The paste in accordance with claim 15 wherein said ferromagnetic particles comprise iron powder and are less than 30 microns in a longest dimension.

19. The paste in accordance with claim 15 wherein said ferromagnetic particles are spherical and less than 30 microns in diameter.

20. The paste in accordance with claim 14 wherein the silicone carrier is a selected one of (i) a silicone resin, (ii) high vacuum silicone grease, and (iii) silicone vacuum thread lubricant.

21. The paste in accordance with claim 13 wherein said ferromagnetic material comprises about 75% by weight iron powder of about −325 mesh, and said carrier comprises about 25% by weight silicone vacuum threaded lubricant.

22. The paste in accordance with claim 13 wherein said ferromagnetic material comprises about 85% by weight Fe3Si spherical powder of particle size less than 20 microns, and said carrier comprises about 15% by weight high vacuum silicone grease.

23. The paste in accordance with claim 13 wherein said ferromagnetic material comprises about 75% by weight FeSiAl spherical powder of particle size less than 10 microns, and said carrier comprises about 25% by weight silicone vacuum thread lubricant.

24. The paste in accordance with claim 13 wherein said ferromagnetic material comprises about 80% by weight FeSiAl spherical powder of particle size less than 10 microns, and said carrier comprises about 20% by weight silicone vacuum thread lubricant.

25. The paste in accordance with claim 13 wherein said ferromagnetic material comprises about 85% by weight FeSiAl spherical powder of particle size less than 10 microns, and said carrier comprises about 15% by weight silicone vacuum thread lubricant.

26. The paste in accordance with claim 13 wherein said ferromagnetic material comprises about 87% by weight FeSiAl spherical powder of particle size less than 10 microns, and said carrier comprises about 13% by weight high temperature epoxy resin.

27. An electrodeless fluorescent lamp assembly comprising:
a closed loop tubular lamp envelope enclosing a fill material for supporting a low pressure discharge;
a transformer core disposed in proximity to said lamp envelope, said transformer core comprising a plurality of core sections;
an input winding disposed on said transformer core for receiving radio frequency energy from a radio frequency source, the radio frequency energy producing the low pressure discharge in said lamp envelope; and
a high magnetic permeability paste disposed between and joining cut surfaces of the core sections, said paste comprising an admixture of ferromagnetic material and a carrier therefor.
